(19) United States
(12) Patent Application Publication
(10) Pub. No.: US 2016/0302105 A1
(43) Pub. Date: Oct. 13, 2016

(54) TECHNIQUES FOR MEDIUM ACCESS CONTROL (MAC) LAYER PACKET ENCAPSULATION AND SEGMENTATION

(71) Applicant: QUALCOMM Incorporated, San Diego, CA (US)

(72) Inventors: Jelena Damnjanovic, Del Mar, CA (US); Fatih Ulupinar, San Diego, CA (US); Aleksandar Damnjanovic, Del Mar, CA (US)

(21) Appl. No.: 15/081,708

(22) Filed: Mar. 25, 2016

Related U.S. Application Data
(60) Provisional application No. 62/145,937, filed on Apr. 10, 2015.

(51) Int. Cl. H04W 28/06

(52) U.S. Cl. CPC H04W 28/065

(57) ABSTRACT

Techniques are described for wireless communication. One method includes encapsulating and segmenting a packet data convergence protocol (PDCP) protocol data unit (PDU), at a medium access control (MAC) layer, to form at least a first MAC service data unit (SDU) and a second MAC SDU; mapping the first MAC SDU to a first MAC PDU and the second MAC SDU to a second MAC PDU; and transmitting the first MAC PDU in a first transport block and the second MAC PDU in a second transport block. In some method examples, the encapsulating may include segmenting the PDCP PDU. In some examples, the method may include transmitting framing information in the first transport block and the second transport block. In some examples, the framing information for a transport block may be transmitted in at least one MAC sub-header of the transport block.

### CROSS REFERENCES

The present Application for Patent claims priority to U.S. Provisional Patent Application No. 62/145,937 by Damnjanovic, et al., entitled “Techniques for Medium Access Control (MAC) Layer Packet Segmentation,” filed Apr. 10, 2015, assigned to the assignee hereof, and which is hereby expressly incorporated by reference herein in its entirety.

### BACKGROUND

1. Field of the Disclosure

The present disclosure, for example, relates to wireless communication systems, and more particularly to techniques for medium access control (MAC) layer packet encapsulation and segmentation.

2. Description of Related Art

Wireless communication systems are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code-division multiple access (CDMA) systems, time-division multiple access (TDMA) systems, frequency-division multiple access (FDMA) systems, and orthogonal frequency-division multiple access (OFDMA) systems.

By way of example, a wireless multiple-access communication system may include a number of wireless devices, such as a number of base stations and a number of user equipments (UEs). Each of the base stations may support simultaneous communications with multiple UEs. The communications between a base station and a UE may include communications on downlink channels (e.g., for transmissions from the base station to the UE) and uplink channels (e.g., for transmissions from the UE to the base station).

Each of the wireless devices in a wireless communication system may communicate with other wireless devices using a protocol stack. In a Long Term Evolution (LTE) or LTE-Advanced (LTE-A) wireless device, the protocol stack may include a Radio Link Control (RLC) layer. One of the functions performed by the RLC layer is packet segmentation and reassembly for communication over logical channels.

### SUMMARY

The present disclosure, for example, relates to techniques for MAC layer packet encapsulation. In an LTE/LTE-A wireless device, the RLC layer performs relatively few functions. Some of these limited functions are packet encapsulation, modification, and segmentation. If one or more of these functions can be moved to another layer of a device's protocol stack, such as the MAC layer, it may be possible to eliminate the RLC layer. Eliminating the RLC layer may reduce the device's implementation complexity or cost, or reduce latency in the data flow through the device's protocol stack.

In a first set of illustrative examples, a method for wireless communication is described. In one example, the method may include encapsulating a packet data convergence protocol (PDCP) protocol data unit (PDU), at a MAC layer, as a first MAC service data unit (SDU); mapping the first MAC SDU to a first MAC PDU; and transmitting the first MAC PDU in a first transport block.

Some examples of the method may further include segmenting for form the PDCP PDU to form the first MAC SDU and a second MAC SDU, mapping the second MAC SDU to a second MAC PDU; and transmitting the second MAC PDU in a second transport block.

In some examples, the method may include transmitting framing information in the first transport block and the second transport block. The framing information may indicate boundaries of PDCP PDUs or boundaries of segments of PDUs included in the first transport block and the second transport block. In some examples, the framing information for a transport block may be transmitted in at least one MAC sub-header of the transport block, and the framing information may indicate whether a MAC SDU corresponds to a beginning segment, a middle segment, or an end segment of a corresponding PDCP PDU.

In some examples, the method may include transmitting, for the first transport block and the second transport block, one or both of a transport block sequence number (TBSN) and a new data indicator (NDI). In some examples, the method may include transmitting, for a transport block included in a retransmission, a segment sequence number (SSN). In some examples, the method may include transmitting the TBSN or the NDI in one or more of a MAC control element, a MAC sub-header, and downlink control information (DCI) on a physical data control channel (PDCCH).

In some examples, the segmenting may also be performed for a retransmission of a third transport block including the PDCP PDU. The third transport block may be transmitted prior to the first transport block and the second transport block. In some examples, the method may include mapping the PDCP PDU, at the MAC layer, to a third MAC SDU; mapping the third MAC SDU to a third MAC PDU; and transmitting the third MAC PDU in the third transport block, prior to the retransmission of the PDCP PDU. In some examples, the retransmission of the third transport block including the PDCP PDU may include one of an automatic repeat request (ARQ) retransmission or a hybrid ARQ (HARD) retransmission. In some examples, the method may include retransmitting a plurality of MAC SDUs included in the third transport block, in a same order, across a plurality of transport blocks comprising at least the first transport block and the second transport block. In some examples, the plurality of MAC SDUs retransmitted across the plurality of transport blocks may be retransmitted at a lower modulation and coding scheme (MCS) than in the third transport block.

In some examples, the method may include mapping each one of a plurality of PDCP PDUs to a single MAC SDU or to a plurality of MAC SDUs; and segmenting, at the MAC layer, each one of the PDCP PDUs mapped to one of the plurality of MAC SDUs. In some examples, a plurality of PDCP PDUs may be transmitted in one or both of the first transport block and the second transport block. In some examples, the first MAC SDU may be an only MAC SDU transmitted in the first transport block or the second MAC SDU may be an only MAC SDU transmitted in the second transport block.

In some examples of the method, the segmenting may be based on one or more of a scheduling decision, a transport block size, and a MCS. In some examples, the method may include receiving an indicator of a MCS in a transmission grant; and performing the segmenting in response to the MCS.

In a second set of illustrative examples, an apparatus for wireless communication is described. In one configuration, the apparatus may include a processor, memory in electronic communication with the processor, and instructions stored in the memory. The instructions may be executable by the processor to encapsulate a PDCP PDU, at a MAC layer, as a first MAC SDU; to map the first MAC SDU to a first MAC PDU; and to transmit the first MAC PDU in a first transport block.

In some examples of the apparatus, the instructions executable by the processor to cause the apparatus to encapsulate the PDCP PDU may further includes instructions executable by the processor to cause the apparatus to: segment the PDCP PDU to form the first MAC SDU and a second MAC SDU, map the second MAC SDU to a second MAC PDU; and transmit the second MAC PDU in a second transport block. In some examples, the instructions may also be executable by the processor to implement one or more aspects of the method for wireless communication described above with respect to the first set of illustrative examples.

In a third set of illustrative examples, a non-transitory computer-readable medium storing computer-executable code for wireless communication is described. In one example, the code may be executable by a processor to encapsulate a packet data convergence protocol (PDCP) protocol data unit (PDU), at a medium access control (MAC) layer, as a first MAC SDU; to map the first MAC SDU to a first MAC PDU; and to transmit the first MAC PDU in a first transport block. In some examples, the code may also be executable by the processor to implement one or more aspects of the method for wireless communication described above with respect to the first set of illustrative examples.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description, and not as a definition of the limits of the claims.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 illustrates an example of a wireless communication system, in accordance with various aspects of the present disclosure;

FIG. 2 shows a data flow through a protocol stack of a wireless device, in accordance with various aspects of the present disclosure;

FIG. 3 shows an exemplary structure of a medium access control (MAC) protocol data unit (PDU), in accordance with various aspects of the present disclosure;

FIG. 4 shows an exemplary sequence of transport blocks transmitted over a wireless communication link, in accordance with various aspects of the present disclosure;

FIG. 5 shows a block diagram of a device for use in wireless communication, in accordance with various aspects of the present disclosure;

FIG. 6 shows a block diagram of a device for use in wireless communication, in accordance with various aspects of the present disclosure;

FIG. 7 shows a block diagram of a base station (e.g., a base station forming part or all of an eNodeB (eNB)) for use in wireless communication, in accordance with various aspects of the present disclosure;

FIG. 8 shows a block diagram of a UE for use in wireless communication, in accordance with various aspects of the present disclosure;

FIG. 9 is a flow chart illustrating an example of a method for wireless communication, in accordance with various embodiments;

FIG. 10 is a flow chart illustrating an example of a method for wireless communication, in accordance with various embodiments; and

FIG. 11 is a flow chart illustrating an example of a method for wireless communication, in accordance with various embodiments.

### DETAILED DESCRIPTION

Techniques are described for eliminating a Radio Link Control (RLC) layer in a Long Term Evolution (LTE) or LTE-Advanced (LTE-A) wireless device. Elimination or reduction of use of the RLC layer in a wireless device may be made possible by shifting functions of the RLC layer to other layers. For example, in currently available LTE/LTE-A wireless devices, the RLC layer may perform, among other limited functions, packet encapsulation and/or segmentation of packet data convergence protocol (PDCP) protocol data units (PDUs). Such functions may enable, for example, the medium access control (MAC) layer to fit data into scheduled transport blocks. However, Hybrid Automatic Repeat Request (HARQ) retransmissions, which are managed at the MAC layer, are not segmented, and therefore the number of information bits transmitted as part of a HARQ retransmission needs to be the same as the number of information bits transmitted in an initial transmission. Although the modulation and coding scheme (MCS) and resource block allocation of the HARQ retransmission can change, the size of the payload may not.

If the RLC layer in a wireless device were eliminated, along with its packet segmentation functionality, the scheduling decision for a downlink transmission may need to be adapted such that it accommodates an integer number of PDCP PDUs. In the case of a large PDCP PDU size (e.g., a size of 1500 bytes) and a low MCS, a long transmission time interval (TTI) may be needed. Furthermore, on the uplink side, inefficiencies may be encountered because the base station may not have information about the packet size or number of packets in a user equipment's (UE's) uplink transmission.

Thus, in some examples described in the disclosure, the RLC layer may be eliminated by having functions normally performed by the RLC layer performed by other means, including by the MAC layer. In some examples, providing MAC layer packet encapsulation and segmentation can address the problems associated with eliminating the RLC layer in a LTE/LTE-A wireless device, and can provide Automatic Repeat Request (ARQ)/HARQ retransmission segmentation, as well as provide desirable information to the base station. For example, layer segmentation may assist the MAC layer fit data into scheduled transport blocks. In another example, eliminating the RLC layer may be facilitated by using a MAC sub-header to transmit information, such framing information of different transport blocks. For example, framing information may indicate boundaries of PDCP PDUs, or of segments of PDUs included in the transport blocks. A MAC sub-header or a MAC control element (or a or downlink control information (DCI) on a physical data control channel (PDCCH)) may also be used to signal transport block sequence number (TBSN), new data indicator (NDI), and/or segment sequence number (SSN), etc.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

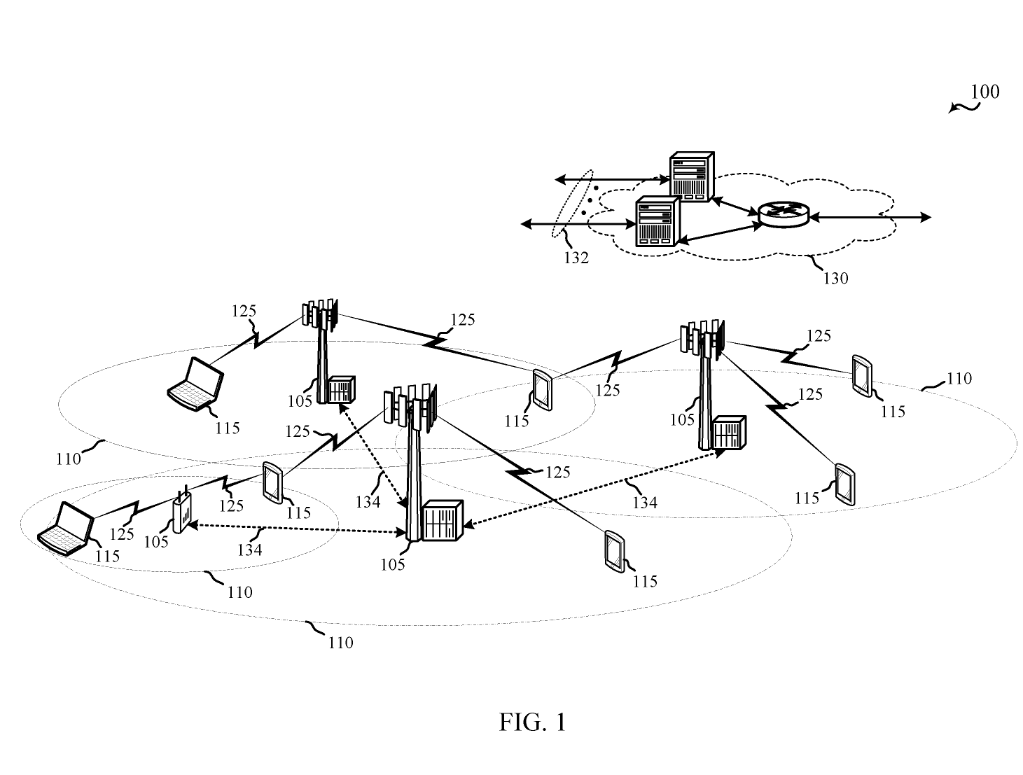

FIG. 1 illustrates an example of a wireless communication system 100, in accordance with various aspects of the present disclosure. The wireless communication system 100 may include base stations 105, UEs 115, and a core network 130. The core network 130 may provide user authentication, access authorization, tracking, Internet Protocol (IP) connectivity, and other access, routing, or mobility functions. The base stations 105 may interface with the core network 130 through backhaul links 134 (e.g., S1, etc.) and may perform radio configuration and scheduling for communication with the UEs 115, or may operate under the control of a base station controller (not shown). In various examples, the base stations 105 may communicate, either directly or indirectly (e.g., through core network 130), with each other over backhaul links 134 (e.g., X1, etc.), which may be wired or wireless communication links.

The base stations 105 may wirelessly communicate with the UEs 115 via at least one base station antenna. Each of the base station 105 sites may provide communication coverage for a respective geographic coverage area 110. In some examples, a base station 105 may be referred to as a base transceiver station, a radio base station, an access point, a radio transceiver, a NodeB, an eNB, a Home NodeB, a Home eNodeB, or some other suitable terminology. The geographic coverage area 110 for a base station 105 may be divided into sectors making up a portion of the coverage area (not shown). The wireless communication system 100 may include base stations 105 of different types (e.g., macro or small cell base stations). There may be overlapping geographic coverage areas 110 for different technologies.

In some examples, the wireless communication system 100 may include an LTE/LTE-A network. In LTE/LTE-A networks, the term eNB may be used to describe the base stations 105 (or entities including one or more base stations 105). The wireless communication system 100 may be a Heterogeneous LTE/LTE-A network in which different types of eNBs provide coverage for various geographical regions. For example, each eNB or base station 105 may provide communication coverage for a macro cell, a small cell, or other types of cell. The term “cell” is a 3GPP term that can be used to describe a base station, a carrier or component carrier associated with a base station, or a coverage area (e.g., sector, etc.) of a carrier or base station, depending on context.

A macro cell may cover a relatively large geographic area (e.g., several kilometers in radius) and may allow unrestricted access by UEs with service subscriptions with the network provider. A small cell may be a lower-powered base station, as compared with a macro cell that may operate in the same or different (e.g., dedicated, shared, etc.) radio frequency spectrums as macro cells. Small cells may include pico cells, femto cells, and micro cells according to various examples. A pico cell may cover a relatively smaller geographic area and may allow unrestricted access by UEs with service subscriptions with the network provider. A femto cell also may cover a relatively small geographic area (e.g., a home) and may provide restricted access by UEs having an association with the femto cell (e.g., UEs in a closed subscriber group (CSG), UEs for users in the home, and the like). An eNB for a macro cell may be referred to as a macro eNB. An eNB for a small cell may be referred to as a small cell eNB, a pico eNB, a femto eNB or a home eNB. An eNB may support one or multiple (e.g., two, three, four, and the like) cells (e.g., component carriers).

The wireless communication system 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. The techniques described herein may be used for either synchronous or asynchronous operations.

The communication networks that may accommodate some of the various disclosed examples may be packet-based networks that operate according to a layered protocol stack. In the user plane, communications at the bearer or PDCP layer may be IP-based. A MAC layer may perform packet segmentation and reassembly to communicate over logical channels, and may also perform priority handling and multiplexing of logical channels into transport channels. The MAC layer may also use HARQ to provide retransmission at the MAC layer to improve link efficiency. In the control plane, a Radio Resource Control (RRC) protocol layer may provide establishment, configuration, and maintenance of an RRC connection between a UE 115 and the base stations 105 or core network 130 supporting radio bearers for the user plane data. At the physical (PHY) layer, transport channels may be mapped to physical channels.

The UEs 115 may be dispersed throughout the wireless communication system 100, and each UE 115 may be stationary or mobile. A UE 115 may also include or be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A UE 115 may be a wireless communication device, a personal computer (e.g., a laptop computer, a netbook computer, a tablet computer, etc.), a handheld device, a cellular telephone, a smart phone, a cordless phone, a wireless modem, a wireless local loop (WLL) station, a personal digital assistant (PDA), a digital video recorder (DVR), an internet appliance, a gaming console, an e-reader, etc. A UE may be able to communicate with various types of base stations and network equipment, including macro eNBs, small cell eNBs, relay base stations, and the like. A UE may also be able to communicate using different radio access technologies (RATs), such as a cellular RAT (e.g., an LTE/LTE-A RAT), a Wi-Fi RAT, or other RATs.

The communication links 125 shown in wireless communication system 100 may include downlink (DL) transmissions, from a base station 105 to a UE 115, or uplink (UL) transmissions, from a UE 115 to a base station 105. The downlink transmissions may also be called forward link transmissions, while the uplink transmissions may also be called reverse link transmissions.

In some examples, each communication link 125 may include at least one carrier, where each carrier may be a signal made up of multiple sub-carriers (e.g., waveform signals of different frequencies) modulated according to the various radio technologies described above. Each modulated signal may be sent on a different sub-carrier and may carry control information (e.g., reference signals, control channels, etc.), overhead information, user data, etc. The communication links 125 may transmit bidirectional communications using a frequency domain duplexing (FDD) operation (e.g., using paired spectrum resources) or a time domain duplexing (TDD) operation (e.g., using unpaired spectrum resources). Frame structures for FDD operation (e.g., frame structure type 1) and TDD operation (e.g., frame structure type 2) may be defined.

In some examples of the wireless communication system 100, base stations 105 or UEs 115 may include multiple antennas for employing antenna diversity schemes to improve communication quality and reliability between base stations 105 and UEs 115. Additionally or alternatively, base stations 105 or UEs 115 may employ multiple-input, multiple-output (MIMO) techniques that may take advantage of multi-path environments to transmit multiple spatial layers carrying the same or different coded data.

The wireless communication system 100 may support operation on multiple cells or carriers, a feature which may be referred to as carrier aggregation (CA) or dual-connectivity operation. A carrier may also be referred to as a component carrier (CC), a layer, a channel, etc. The terms “carrier,” “component carrier,” “cell,” and “channel” may be used interchangeably herein. A UE 115 may have multiple downlink CCs and at least one uplink CC for carrier aggregation. Carrier aggregation may be used with both FDD and TDD component carriers.

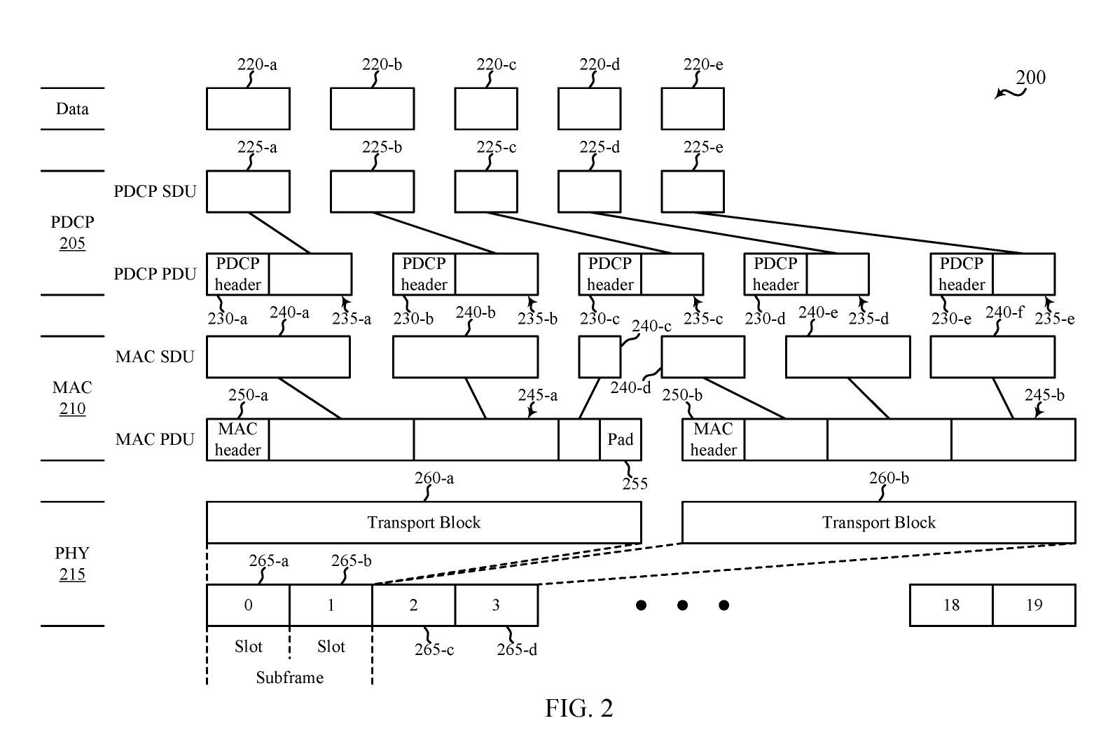

FIG. 2 shows a data flow 200 through a protocol stack of a wireless device, in accordance with various aspects of the present disclosure. In some embodiments, the wireless device may be an example of one or more aspects of the base stations 105 or UEs 115 described with reference to FIG. 1.

The protocol stack may include a PDCP layer 205, a MAC layer 210, and a PHY layer 215. In some examples, the protocol stack may include other layers; however, the protocol stack need not include a RLC layer. Data for transmission over a wireless communication link (e.g., a number of Internet Protocol (IP) packets 220, such as IP packets 220-a, 220-b, 220-c, 220-d, and 220-e) may be received by the PDCP layer 205.

Each IP packet 220 may be received at the PDCP layer 205 and be mapped to a corresponding PDCP SDU 225 (e.g., IP packet 220-a may be mapped to PDCP SDU 225-a, IP packet 220-b may be mapped to PDCP SDU 225-b, IP packet 220-c may be mapped to PDCP SDU 225-c, IP packet 220-d may be mapped to PDCP SDU 225-d, and IP packet 220-e may be mapped to PDCP SDU 225-e). At the PDCP layer 205, a PDCP header 230 (e.g., PDCP header 230-a, 230-b, 230-c, 230-d, or 230-e) may be added to each PDCP SDU 225 to form a respective PDCP PDU 235 (e.g., PDCP PDU 235-a, 235-b, 235-c, 235-d, or 235-e).

Each PDCP PDUs 235 may be received at the MAC layer 210 and be mapped to one or more MAC SDUs 240. Some PDCP PDUs 235 may be mapped to a single MAC SDU 240. Other PDCP PDUs 235 may be segmented and mapped to two or more MAC SDUs 240. Thus, for example, PDCP PDU 235-a may be mapped to MAC SDU 240-a, PDCP PDU 235-b may be mapped to MAC SDU 240-b, different segments of PDCP PDU 235-c may be mapped to MAC SDU 240-c and MAC SDU 240-d, PDCP PDU 235-d may be mapped to MAC SDU 240-e, and PDCP PDU 235-e may be mapped to MAC SDU 240-f. Also at the MAC layer 210, each MAC SDU 240 may be mapped to a MAC PDU 245 (e.g., MAC PDU 245-a or 245-b). By way of example, the MAC SDUs 240-a, 240-b, and 240-c may be mapped to the MAC PDU 245-a, and the MAC SDUs 240-d, 240-e, and 240-f may be mapped to the MAC PDU 245-b. The segmentation of PDCP PDUs 235 and mapping of MAC SDUs 240 to MAC PDUs 245 may be based on a scheduling decision (e.g., a scheduling decision based at least in part on a transport block size or a MCS).

Still further at the MAC layer 210, a MAC header 250 (e.g., MAC header 250-a or 250-b) may be added to each MAC PDU 245. When needed to fill a transport block, padding (e.g., Pad 255) may also be added to a MAC PDU 245.

Each MAC PDU 245 may be received at the PHY layer 215 and be mapped to a corresponding transport block 260 (e.g., MAC PDU 245-a may be mapped to transport block 260-a, and MAC PDU 245-b may be mapped to transport block 260-b). Also at the PHY layer 215, each transport block 260 may be transmitted during a transmission time interval (TTI) of a wireless communication link. For example, transport block 260-a may be transmitted during a subframe including a Slot 0 265-a and a Slot 1 266-b, and transport block 260-b may be transmitted during a subframe including a Slot 2 265-c and a Slot 3 265-d. In examples in which the transport blocks 260 belong to a downlink transmission, the transport blocks 260 may be transmitted on a physical downlink shared channel (PDSCH).

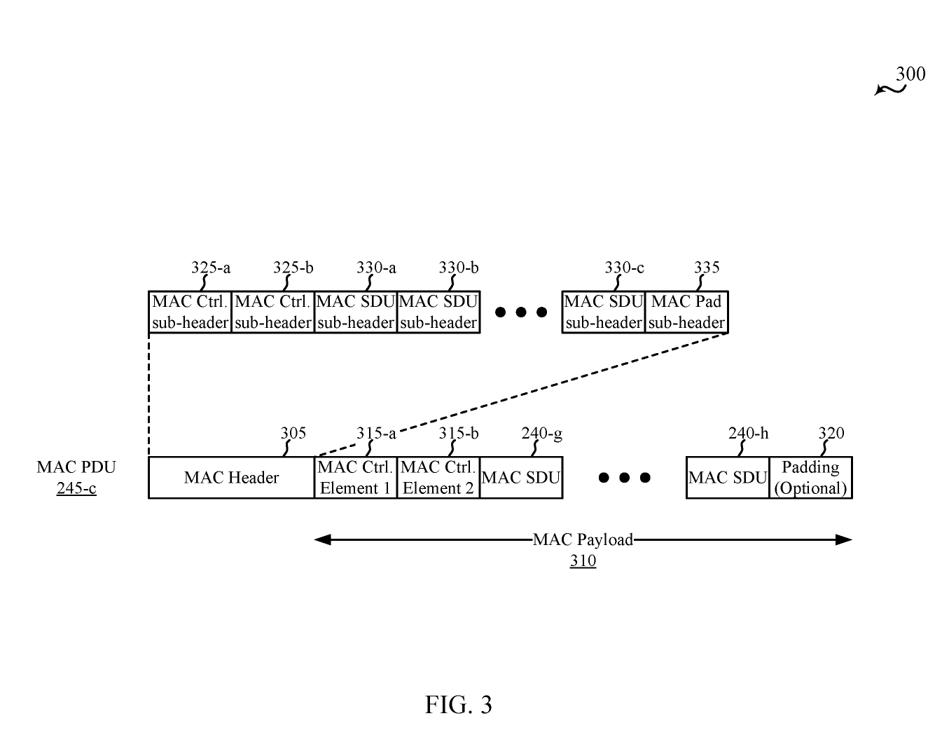

FIG. 3 shows an exemplary structure 300 of a MAC PDU 245-c, in accordance with various aspects of the present disclosure. In some embodiments, the MAC PDU 245-c may be an example of one or more aspects of the MAC PDUs 245 described with reference to FIG. 2. By way of example, the MAC PDU 245-c may include a MAC header 305 and a MAC payload 310. The MAC payload 310 may include a number of MAC control elements 315 (e.g., MAC Ctrl. Element 1 315-a and MAC Ctrl. Element 2 315-b), a number of MAC SDUs 240 (e.g., MAC SDUs 240-g and 240-h), and optional padding 320.

The MAC header 305 may include a number of MAC sub-headers, such as a number of MAC control sub-headers 325 (e.g., MAC Ctrl. sub-headers 325-a and 325-b), a number of MAC SDU sub-headers 330 (e.g., MAC SDU sub-headers 330-a, 330-b, and 330-c), or a number of MAC padding sub-headers (e.g., MAC padding sub-header 335). Each of the MAC control sub-headers 325 may include a number of reserved bits (e.g., 2 bits), a number of bits indicating whether more MAC sub-headers are present in the MAC header 305 (e.g., an extension bit), or a number of bits indicating a type of control element (e.g., 5 bits). Each of the MAC SDU sub-headers 330 may include a number of bits indicating framing information for a corresponding MAC SDU 240 (e.g., 2 bits), a number of bits indicating whether more MAC sub-headers are present in the MAC header 305 (e.g., an extension bit), a number of bits indicating a logical channel ID for the information included in a MAC SDU 240 (e.g., 5 bits), a number of bits indicating a format of a subsequent length field (e.g., 1 bit), and a number of bits indicating a length of a corresponding MAC SDU 240 (e.g., 7 or 15 bits). Each of the MAC padding sub-headers 335 may include a number of reserved bits (e.g., 2 bits), a number of bits indicating whether more MAC sub-headers are present in the MAC header 305 (e.g., an extension bit), or a number of bits indicating a padding element (e.g., 5 bits).

The bits of a MAC SDU sub-header 330 indicating framing information may indicate, for example, whether a corresponding MAC SDU 240 corresponds to a beginning segment, a middle segment, or an end segment of a corresponding PDCP PDU. The framing information may also indicate whether a corresponding MAC SDU 240 includes an entire PDCP PDU. For example, two bits of framing information (F1) may indicate:

| FI | Data field of corresponding MAC SDU includes: |
|---|---|
| 00 | First byte of a PDCP PDU, and last byte of the PDCP PDU |
| 01 | First byte of a PDCP PDU, but not the last byte of the PDCP PDU |
| 10 | Not the first byte of a PDCP PDU, but the last byte |
| | of the PDCP PDU |
| 11 | Not the first byte of a PDCP PDU nor the last byte |
| | of the PDCP PDU |

A MAC control element 315 or a MAC sub-header (e.g., a MAC control sub-header 325) may be used to indicate a TBSN, a NDI, or a SSN. A TBSN may identify a transport block in which the information included in the MAC PDU 245-c is (or was) initially transmitted. The same TBSN may be included in a transmission or retransmission of the information included in the MAC PDU 245-c. A NDI may indicate whether the information included in the MAC PDU 245-c is being initially transmitted or retransmitted. When the information included in the MAC PDU 245-c is being retransmitted and represents only part of the information that was initially transmitted in a single transport block (e.g., because the information that was initially transmitted in the single transport block is now being retransmitted at a lower MCS over multiple transport blocks), a SSN may indicate whether the information included in the MAC PDU 245-c represents a first segment, second segment, third segment, etc. of the initially transmitted transport block. A SSN may also indicate how many segments are being transmitted. For example, a SSN may take one of the following values:

| SSN | Description: |
|---|---|
| 0 | One segment is being transmitted |
| 1 | Two segments are being transmitted, and this transport |
| | block includes the first segment |
| 2 | Two segments are being transmitted, and this transport |
| | block includes the second segment |
| 3 | Reserved |

A SSN may enable a receiver to detect when a transport block corresponding to a retransmission has not been received.

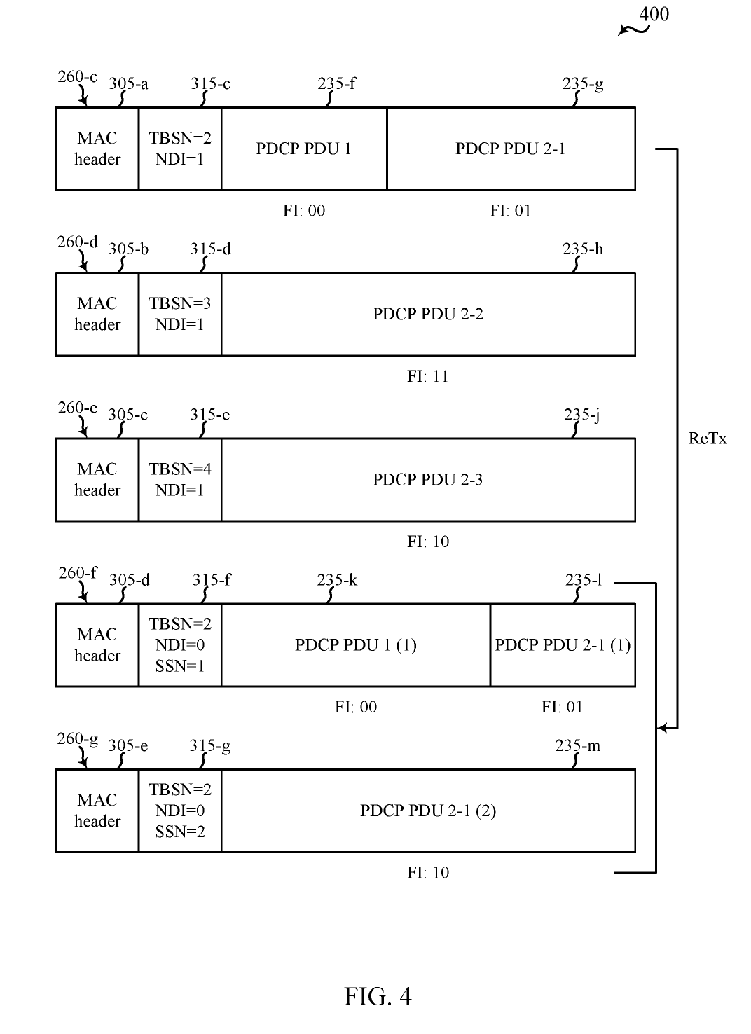

FIG. 4 shows an exemplary sequence 400 of transport blocks 260 transmitted over a wireless communication link, in accordance with various aspects of the present disclosure. In some examples, each of the transport blocks 260 may include a MAC PDU 245 formatted as described with reference to FIG. 3. In some examples, the transport blocks 260 may be transmitted by a wireless device such as one of the base stations 105 or UEs 115 described with reference to FIG. 1.

By way of example, a first transport block 260-c, which may or may not represent the beginning transport block in a wireless transmission, may include a MAC header 305-a, a MAC control element 315-c, a PDCP PDU 1 235-f (which may also be referred to as a MAC SDU), and a beginning segment of a PDCP PDU 2 (e.g., PDCP PDU 2-1 235-g). The framing information included in the MAC header 305-a for PDCP PDU 1 235-f (e.g., FI: 00) may indicate that the entirety of PDCP PDU 1 325-f is being transmitted, while the framing information included in the MAC header 305-a for PDCP PDU 2-1 235-g (e.g., FI: 01) may indicate that a beginning segment of PDCP PDU 2 is being transmitted. The MAC control element 315-c may indicate TBSN=2 and NDI=1 (i.e., that this is an initial transmission of transport block 2).

A second transport block 260-d may include a MAC header 305-b, a MAC control element 315-d, and a middle segment of the PDCP PDU 2 (e.g., PDCP PDU 2-2 235-h). The framing information included in the MAC header 305-b for PDCP PDU 2-2 235-h (e.g., FI: 11) may indicate that a middle segment of PDCP PDU 2 is being transmitted. The MAC control element 315-d may indicate TBSN=3 and NDI=1 (i.e., that this is an initial transmission of transport block 3).

A third transport block 260-e may include a MAC header 305-c, a MAC control element 315-e, and a segment of the PDCP PDU 2 (e.g., PDCP PDU 2-3 235-j). The framing information included in the MAC header 305-c for PDCP PDU 2-3 235-j (e.g., FI: 10) may indicate that an end segment of PDCP PDU 2 is being transmitted. The MAC control element 315-e may indicate TBSN=4 and NDI=1 (i.e., that this is an initial transmission of transport block 4).

A fourth transport block 260-f may include a MAC header 305-d, a MAC control element 315-f, a retransmission of PDCP PDU 1 (e.g., PDCP PDU 1 (1) 235-k), and a beginning segment of the beginning segment of PDCP PDU 2 (e.g., PDCP PDU 2-1 (1) 235-1). The framing information included in the MAC header 305-d for PDCP PDU 1 (1) 235-k (e.g., FI: 00) may indicate that the entirety of PDCP PDU 1 is being retransmitted, while the framing information included in the MAC header 305-d for PDCP PDU 2-1 (1) 235-1 (e.g., FI: 01) may indicate that a beginning segment of the beginning segment of PDCP PDU 2 is being transmitted. The MAC control element 315-f may indicate TBSN=2, NDI=0, and SSN=1 (i.e., that this transport block corresponds to a retransmission (ReTx) of transport block 2, and that the PDCP PDU 2-1 (1) 235-l is a first segment of a retransmission of PDCP PDU 2-1 235-g).

A fifth transport block 260-g may include a MAC header 305-e, a MAC control element 315-g, and an end segment of the beginning segment of PDCP PDU 2 (e.g., PDCP PDU 2-1 (2) 235-m). The framing information included in the MAC header 305-e for PDCP PDU 2-1 (2) 235-m (e.g., FI: 10) may indicate that an end segment of the beginning segment of PDCP PDU 2 is being transmitted. The MAC control element 315-g may indicate TBSN=2, NDI=0, and SSN=2 (i.e., that this transport block corresponds to a retransmission of transport block 2, and that the PDCP PDU 2-1 (2) 235-m is a second segment of a retransmission of PDCP PDU 2-1 235-g).

In the example shown in FIG. 4, the retransmission of the beginning segment of PDCP PDU 2 (e.g., PDCP PDU 2-1 235-g) may extend over multiple transport blocks because the transport blocks 260-f and 260-g are transmitted at a lower MCS than the transport block 260-c. When retransmitting a transport block, the retransmission of the transport block should not be multiplexed with the data of another transport block.

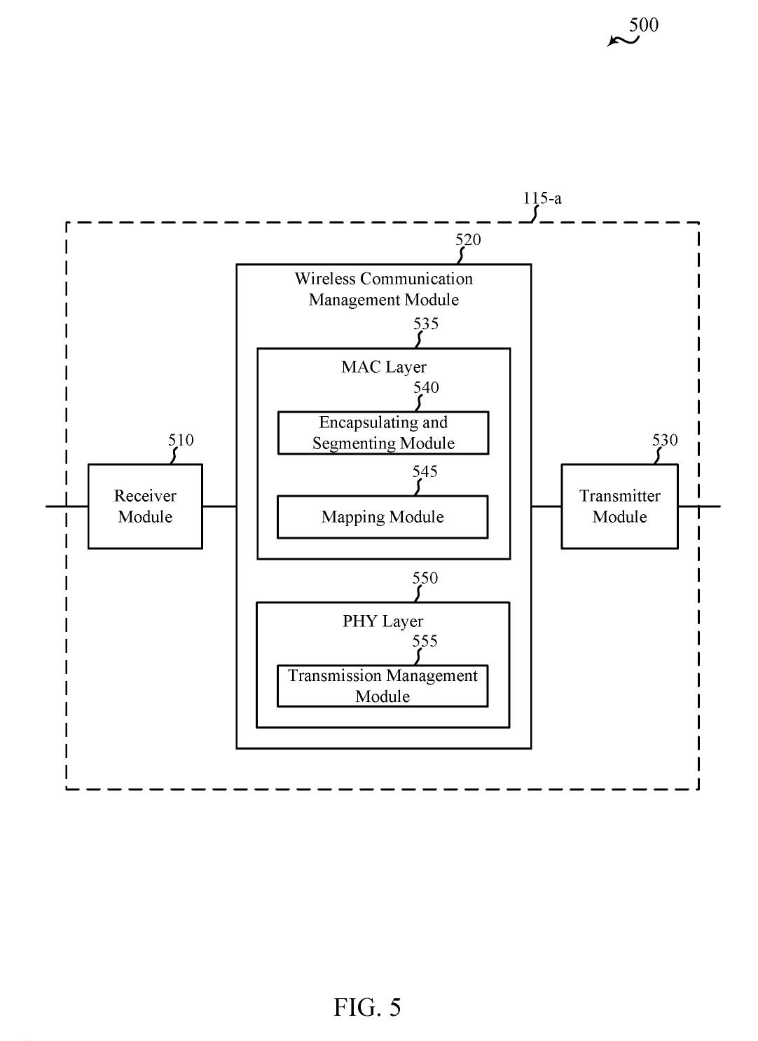

FIG. 5 shows a block diagram 500 of a device 505 for use in wireless communication, in accordance with various aspects of the present disclosure. The device 505 may be an example of aspects of one or more of the base stations 105 or UEs 115 described with reference to FIG. 1. The device 505 may also be or include a processor. The device 505 may include a receiver module 510, a wireless communication management module 520, or a transmitter module 530. Each of these components may be in communication with each other.

The components of the device 505 may, individually or collectively, be implemented using one or more application-specific integrated circuits (ASICs) adapted to perform some or all of the applicable functions in hardware. Alternatively, the functions may be performed by one or more other processing units (or cores), on one or more integrated circuits. In other examples, other types of integrated circuits may be used (e.g., Structured/Platform ASICs, Field Programmable Gate Arrays (FPGAs), a System-on-Chip (SoC), and/or other types of Semi-Custom ICs), which may be programmed in any manner known in the art. The functions of each module may also be implemented, in whole or in part, with instructions embodied in a memory, formatted to be executed by one or more general or application-specific processors.

In some examples, the receiver module 510 may include at least one radio frequency (RF) receiver. The receiver module 510 or RF receiver may be used to receive various types of data or control signals (i.e., transmissions) over one or more communication links of a wireless communication system, such as one or more communication links of the wireless communication system 100 described with reference to FIG. 1. In some examples, the transmissions may include LTE/LTE-A communications.

In some examples, the transmitter module 530 may include at least one RF transmitter. The transmitter module 530 or RF transmitter may be used to transmit various types of data or control signals (i.e., transmissions) over one or more communication links of a wireless communication system, such as one or more communication links of the wireless communication system 100 described with reference to FIG. 1. In some examples, the transmissions may include LTE/LTE-A communications.

The wireless communication management module 520 may be used to manage one or more aspects of wireless communication for the device 505. In some examples, the wireless communication management module 520 may include a MAC layer 535 or a PHY layer 550. The MAC layer 535 may include an encapsulating and segmenting module 540 or a mapping module 545. The PHY layer 550 may include a transmission management module 555. In some examples, some or all of the components of the wireless communication management module 520 may be incorporated into (or provided by) the receiver module 510 or the transmitter module 530.

The encapsulating and segmenting module 540 may encapsulate a PDCP PDU, at the MAC layer 535, as a first MAC SDU and a second MAC SDU. In some examples, the encapsulating may include segmenting, which, may be performed for an initial transmission of the PDCP PDU or a retransmission of the PDCP PDU. In some cases, the segmenting may be based at least in part on a scheduling decision of the device 505 (e.g., a scheduling decision based at least in part on a transport block size or a MCS).

The mapping module 545 may be used to map the first MAC SDU to a first MAC PDU, and in some cases map the second MAC SDU to a second MAC PDU.

The transmission management module 555 may be used to transmit the first MAC PDU in a first transport block and transmit the second MAC PDU in a second transport block. In some cases the first MAC SDU may be an only MAC SDU transmitted in the first transport block, or the second MAC SDU may be an only MAC SDU transmitted in the second transport block. In some cases, the first transport block may include a first plurality of MAC SDUs, and thus, a first plurality of PDCP PDUs. In some cases, the second transport block may include a second plurality of MAC SDUs, and thus, a second plurality of PDCP PDUs.

In some examples of the device 505, the MAC layer 535 may receive a plurality of PDCP PDUs, and each of the PDCP PDUs may be mapped to a single MAC SDU or a plurality of MAC SDUs at the MAC layer 535. When a PDCP PDU is mapped to a plurality of MAC SDUs, the encapsulating and segmenting module 540 may encapsulate the PDCP PDU, which may in some examples include segmenting the PDCP PDU between the plurality of MAC SDUs.

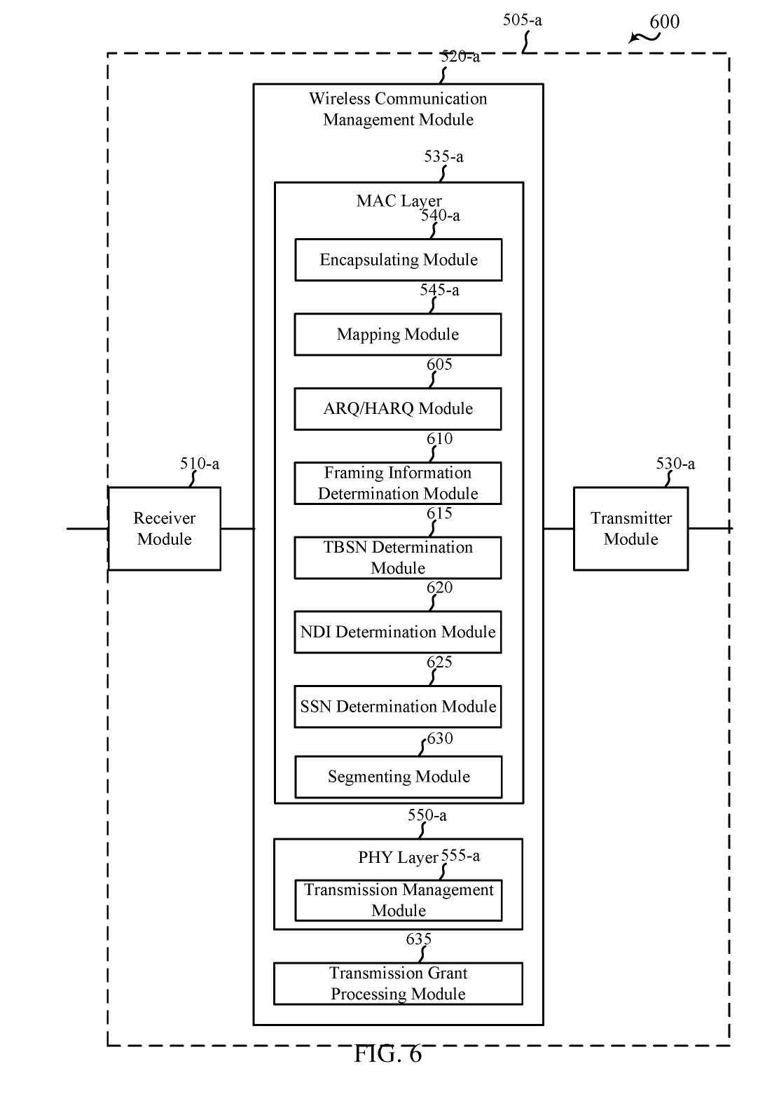

FIG. 6 shows a block diagram 600 of a device 505-a for use in wireless communication, in accordance with various aspects of the present disclosure. The device 505-a may be an example of aspects of one or more of the base stations 105 or UEs 115 described with reference to FIG. 1, or an example of aspects of the device 505 described with reference to FIG. 5. The device 505-a may also be or include a processor. The device 505-a may include a receiver module 510-a, a wireless communication management module 520-a, or a transmitter module 530-a, which may be respective examples of the receiver module 510, the wireless communication management module 520, and the transmitter module 530 described with reference to FIG. 5. Each of these components may be in communication with each other.

The components of the device 505-a may, individually or collectively, be implemented using one or more ASICs adapted to perform some or all of the applicable functions in hardware. Alternatively, the functions may be performed by one or more other processing units (or cores), on one or more integrated circuits. In other examples, other types of integrated circuits may be used (e.g., Structured/Platform ASICs, FPGAs, a SoC, and/or other types of Semi-Custom ICs), which may be programmed in any manner known in the art. The functions of each module may also be implemented, in whole or in part, with instructions embodied in a memory, formatted to be executed by one or more general or application-specific processors.

The wireless communication management module 520-a may be used to manage one or more aspects of wireless communication for the device 505-a. In some examples, the wireless communication management module 520-a may include a MAC layer 535-a, a PHY layer 550-a, or an optional transmission grant processing module 635. The MAC layer 535-a may include an encapsulating module 540-a, a mapping module 545-a, an ARQ/HARQ module 605, a framing information determination module 610, a TBSN determination module 615, a NDI determination module 620, a SSN determination module 625, or a segmenting module 630. The PHY layer 550-a may include a transmission management module 555-a. In some examples, some or all of the components of the wireless communication management module 520-a may be incorporated into (or provided by) the receiver module 510-a or the transmitter module 530-a.

The mapping module 545-a may be used to map a PDCP PDU, at a MAC layer, to a first MAC SDU. In some cases, the mapping may be based at least in part on a scheduling decision of the device 505-a (e.g., a scheduling decision based at least in part on a transport block size or a MCS). The mapping module 545-a may also be used to map the first MAC SDU to a first MAC PDU.

The transmission management module 555-a may be used to transmit the first MAC PDU in a first transport block, as part of an initial transmission of the first MAC PDU (and the first MAC SDU and PDCP PDU included therein). In some cases the first MAC SDU may be an only MAC SDU transmitted in the first transport block. In some cases, the first transport block may include a first plurality of MAC SDUs, and thus, a first plurality of PDCP PDUs.

The ARQ/HARQ module 605 may be used to determine that the first transport block was not received by a receiving device (e.g., by receiving a non-acknowledgement from the receiving device, or by not receiving an acknowledgement from the receiving device). The ARQ/HARQ module 605 may also determine to retransmit the first transport block. In some examples, the information included in the first transport block (e.g., MAC PDU, MAC SDU(s), and MAC PDU(s)) may be retransmitted in a same order, but at a lower MCS. When transmitted at a lower MCS, and assuming a same transport block size, the information may be retransmitted across a plurality of transport blocks.

The encapsulating module 540-a may encapsulate a PDCP PDU, at the MAC layer 535-a, as a first MAC SDU. In some examples, the segmenting module 630 may also be used to segment the PDCP PDU, for example to form the first MAC SDU, as well a second MAC SDU, and potentially a third MAC SDU. The segmenting may be performed for a retransmission (e.g., an ARQ retransmission or a HARQ retransmission) of the first transport block. In some cases, the segmenting may be based at least in part on a scheduling decision (e.g., a scheduling decision based at least in part on a transport block size or a MCS). In some cases, the MCS on which the segmenting is based may be a lower or a different MCS than the MCS used for transmitting the first transport block. In some examples, the segmenting may be performed for an initial transmission of the PDCP PDU

The mapping module 545-a may be used to map the second MAC SDU to a second MAC PDU and map the third MAC SDU to a third MAC PDU.

The transmission management module 555-a may be used to transmit the second MAC PDU in a second transport block and transmit the third MAC PDU in a third transport block. In some cases the second MAC SDU may be an only MAC SDU transmitted in the second transport block, or the third MAC SDU may be an only MAC SDU transmitted in the third transport block. In some cases, the second transport block may include a second plurality of MAC SDUs, and thus, a second plurality of PDCP PDUs. In some cases, the third transport block may include a third plurality of MAC SDUs, and thus, a third plurality of PDCP PDUs.

In some examples of the device 505-a, the MAC layer 535-a may receive a plurality of PDCP PDUs, and each of the PDCP PDUs may be mapped to a single MAC SDU or a plurality of MAC SDUs at the MAC layer 535-a. When a PDCP PDU is mapped to a plurality of MAC SDUs, the segmenting module 630 may segment the PDCP PDU between the plurality of MAC SDUs.

In some examples of the device 505-a, each of the transport blocks transmitted using the transmission management module 555-a may include framing information, which framing information may be determined using the framing information determination module 610. The framing information included in a transport block may indicate boundaries of PDCP PDUs or boundaries of segments of PDUs included in the transport block, as described with reference to FIG. 3 or 4.

In some examples of the device 505-a, a TBSN or NDI may be transmitted for each of the transport blocks transmitted using the transmission management module 555-a. In some cases, the TBSN or NDI for a transport block may be transmitted in at least one of a MAC control element, a MAC sub-header, or DCI on a PDCCH. When the transport blocks are included in a retransmission, a SSN may also be transmitted for each of the transport blocks. A TBSN may be determined using the TBSN determination module 615. A NDI may be determined using the NDI determination module 620. A SSN may be determined using the SSN determination module 625. Additional details on determining and transmitting a TBSN, NDI, or SSN are described in greater detail in FIGS. 3 and 4.

In some examples of the device 505-a (e.g., examples in which the device 505-a is part of a UE 115), the transmission grant processing module 635 may be used to receive an indicator of a MCS in a transmission grant (e.g., in an uplink grant). The transmission grant processing module 635 may also cause the segmenting module 630 to perform segmenting in response to the MCS.

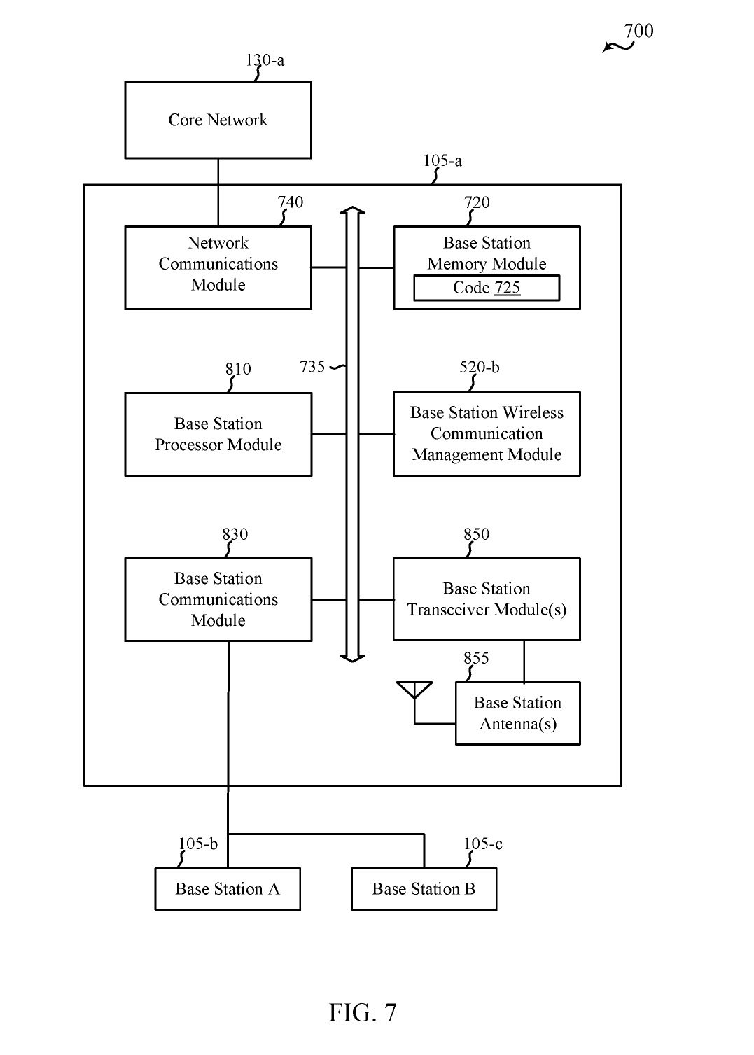

FIG. 7 shows a block diagram 700 of a base station 105-a (e.g., a base station forming part or all of an eNB) for use in wireless communication, in accordance with various aspects of the present disclosure. In some examples, the base station 105-a may be an example of aspects of one or more of the base stations 105 or devices 505 described with reference to FIG. 1, 5, or 6. The base station 105-a may be configured to implement or facilitate at least some of the base station features and functions described with reference to FIGS. 1-6.

The base station 105-a may include a base station processor module 710, a base station memory module 720, at least one base station transceiver module (represented by base station transceiver module(s) 750), at least one base station antenna (represented by base station antenna(s) 755), or a base station wireless communication management module 520-b. The base station 105-a may also include one or more of a base station communications module 730 or a network communications module 740. Each of these components may be in communication with each other, directly or indirectly, over one or more buses 735.

The base station memory module 720 may include random access memory (RAM) or read-only memory (ROM). The base station memory module 720 may store computer-readable, computer-executable code 725 containing instructions that are configured to, when executed, cause the base station processor module 710 to perform various functions described herein related to wireless communication, including, for example, the MAC layer segmentation functions described with reference to FIGS. 2-6. Alternatively, the code 725 may not be directly executable by the base station processor module 710 but be configured to cause the base station 105-a (e.g., when compiled and executed) to perform various of the functions described herein.

The base station processor module 710 may include an intelligent hardware device, e.g., a central processing unit (CPU), a microcontroller, an ASIC, etc. The base station processor module 710 may process information received through the base station transceiver module(s) 750, the base station communications module 730, or the network communications module 740. The base station processor module 710 may also process information to be sent to the transceiver module(s) 750 for transmission through the antenna(s) 755, to the base station communications module 730, for transmission to one or more other base stations 105-b and 105-c, or to the network communications module 740 for transmission to a core network 130-a, which may be an example of one or more aspects of the core network 130 described with reference to FIG. 1. The base station processor module 710 may handle, alone or in connection with the base station wireless communication management module 520-b, various aspects of communicating over (or managing communications over) one or more communication links with a number of UEs.

The base station transceiver module(s) 750 may include a modem configured to modulate packets and provide the modulated packets to the base station antenna(s) 755 for transmission, and to demodulate packets received from the base station antenna(s) 755. The base station transceiver module(s) 750 may, in some examples, be implemented as one or more base station transmitter modules and one or more separate base station receiver modules. The base station transceiver module(s) 750 may support communications over one or more wireless channels. The base station transceiver module(s) 750 may be configured to communicate bi-directionally, via the antenna(s) 755, with one or more UEs or other devices, such as one or more of the UEs 115 or devices 505 described with reference to FIG. 1, 5, or 6. The base station 105-a may, for example, include multiple base station antennas 755 (e.g., an antenna array). The base station 105-a may communicate with the core network 130-a through the network communications module 740. The base station 105-a may also communicate with other base stations, such as the base stations 105-b and 105-c, using the base station communications module 730.

The base station wireless communication management module 520-b may be configured to perform or control some or all of the features or functions described with reference to FIGS. 1-6. The base station wireless communication management module 520-b, or portions of it, may include a processor, or some or all of the functions of the base station wireless communication management module 520-b may be performed by the base station processor module 710 or in connection with the base station processor module 710. In some examples, the base station wireless communication management module 520-b may be an example of the wireless communication management module 520 described with reference to FIG. 5 or 6.

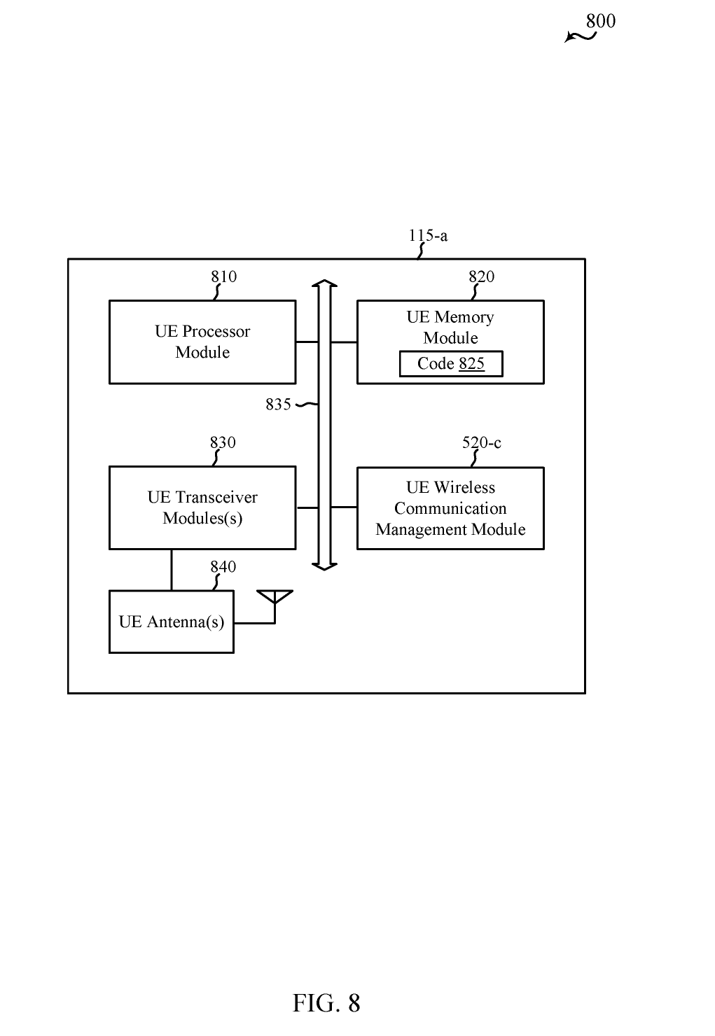

FIG. 8 shows a block diagram 800 of a UE 115-a for use in wireless communication, in accordance with various aspects of the present disclosure. The UE 115-a may have various configurations and may be a wireless communication device, a personal computer (e.g., a laptop computer, a netbook computer, a tablet computer, etc.), a handheld device, a cellular telephone, a smart phone, a cordless phone, a wireless modem, a wireless local loop (WLL) station, a personal digital assistant (PDA), a digital video recorder (DVR), an internet appliance, a gaming console, an e-reader, etc. The UE 115-a may, in some examples, have an internal power supply (not shown), such as a small battery, to facilitate mobile operation. In some examples, the UE 115-a may be an example of aspects of one or more of the UEs 115 or devices 505 described with reference to FIG. 1, 5, or 6. The UE 115-a may be configured to implement at least some of the UE or device features and functions described with reference to FIGS. 1-6.

The UE 115-a may include a UE processor module 810, a UE memory module 820, at least one UE transceiver module (represented by UE transceiver module(s) 830), at least one UE antenna (represented by UE antenna(s) 840), or a UE wireless communication management module 520-c. Each of these components may be in communication with each other, directly or indirectly, over one or more buses 835.

The UE memory module 820 may include RAM or ROM. The UE memory module 820 may store computer-readable, computer-executable code 825 containing instructions that are configured to, when executed, cause the UE processor module 810 to perform various functions described herein related to wireless communication, including, for example, the MAC layer segmentation functions described with reference to FIGS. 2-6. Alternatively, the code 825 may not be directly executable by the UE processor module 810 but be configured to cause the UE 115-a (e.g., when compiled and executed) to perform various of the functions described herein.

The UE processor module 810 may include an intelligent hardware device, e.g., a CPU, a microcontroller, an ASIC, etc. The UE processor module 810 may process information received through the UE transceiver module(s) 830 or information to be sent to the UE transceiver module(s) 830 for transmission through the UE antenna(s) 840. The UE processor module 810 may handle, alone or in connection with the UE wireless communication management module 520-c, various aspects of communicating over (or managing communications over) one or more communication links with a base station.

The UE transceiver module(s) 830 may include a modem configured to modulate packets and provide the modulated packets to the UE antenna(s) 840 for transmission, and to demodulate packets received from the UE antenna(s) 840. The UE transceiver module(s) 830 may, in some examples, be implemented as one or more UE transmitter modules and one or more separate UE receiver modules. The UE transceiver module(s) 830 may support communications over one or more wireless channels. The UE transceiver module(s) 830 may be configured to communicate bi-directionally, via the UE antenna(s) 840, with one or more base stations or other devices, such as one or more of the base stations 105 or devices 505 described with reference to FIG. 1, 5, or 6. While the UE 115-a may include a single UE antenna, there may be examples in which the UE 115-a may include multiple UE antennas 840.

The UE wireless communication management module 520-c may be configured to perform or control some or all of the UE or device features or functions described with reference to FIGS. 1-6. The UE wireless communication management module 520-c, or portions of it, may include a processor, or some or all of the functions of the UE wireless communication management module 520-c may be performed by the UE processor module 810 or in connection with the UE processor module 810. In some examples, the UE wireless communication management module 520-c may be an example of the wireless communication management module 520 described with reference to FIG. 5 or 6.

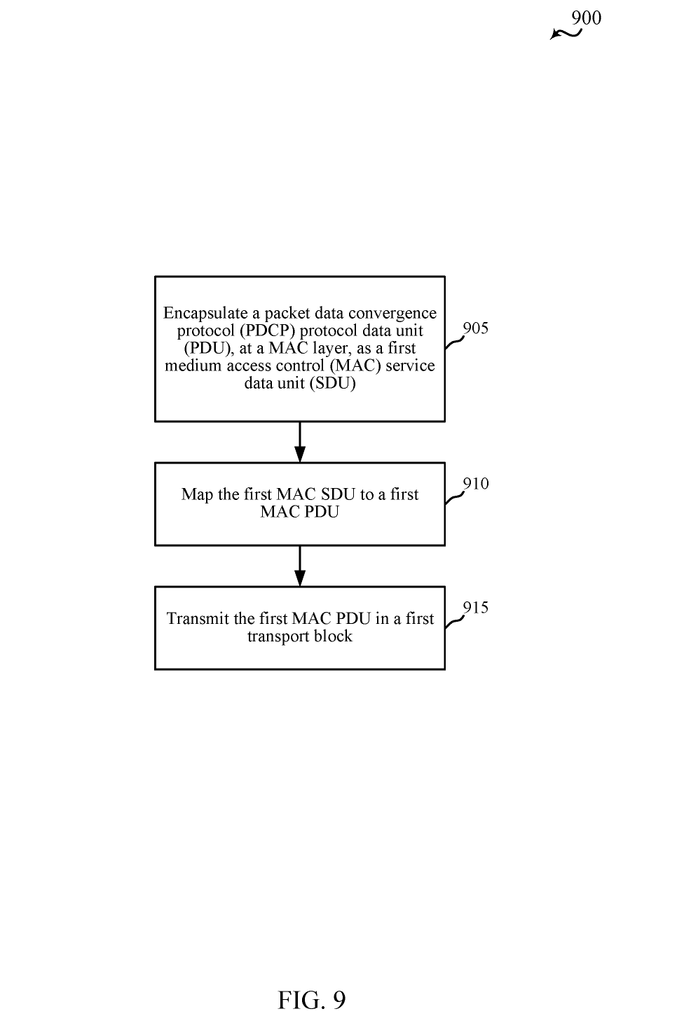

FIG. 9 is a flow chart illustrating an example of a method 900 for wireless communication, in accordance with various embodiments. For clarity, the method 900 is described below with reference to aspects of a wireless device, such as a wireless device including aspects of one or more of the base stations 105 or UEs 115 described with reference to FIG. 1, 5, 6, 7, or 8. In some examples, a wireless device may execute one or more sets of codes to control the functional elements of the wireless device to perform the functions described below.

At block 905, a wireless device may encapsulate a PDCP PDU, at a MAC layer, as a first MAC SDU. The encapsulating may be performed for an initial transmission of the PDCP PDU or a retransmission of the PDCP PDU. In some cases, the encapsulating may be based at least in part on a scheduling decision. The operation(s) at block 905 may be performed using the wireless communication management module 520 described with reference to FIG. 5, 6, 7, or 8, or the MAC layer 535 or encapsulating and segmenting module 540 described with reference to FIG. 5 or 6.

At block 910, the wireless device may map the first MAC SDU to a first MAC PDU and map the second MAC SDU to a second MAC PDU. The operation(s) at block 910 may be performed using the wireless communication management module 520 described with reference to FIG. 5, 6, 7, or 8, or the MAC layer 535 or mapping module 545 described with reference to FIG. 5 or 6.

At block 915, the wireless device may transmit the first MAC PDU in a first transport block. In some cases the first MAC SDU may be an only MAC SDU transmitted in the first transport block. In some cases, the first transport block may include a first plurality of MAC SDUs, and thus, a first plurality of PDCP PDUs. The operation(s) at block 915 may be performed using the wireless communication management module 520 described with reference to FIG. 5, 6, 7, or 8, or the PHY layer 550 or transmission management module 555 described with reference to FIG. 5 or 6.

In some examples of the method 900, the first transport block transmitted at block 915 may include framing information. For example, the framing information included in the first transport block may indicate boundaries of PDCP PDUs included in the transport block, as described with reference to FIG. 3 or 4. In some examples of the method 900, a TBSN or NDI may be transmitted for the first transport block transmitted at block 915. In some cases, the TBSN or NDI for the first transport block may be transmitted in at least one of a MAC control element, a MAC sub-header, or DCI on a PDCCH. When the first transport block is included in a retransmission, a SSN may also be transmitted for the first transport block. Additional details on determining and transmitting a TBSN, NDI, or SSN are described in greater detail in FIGS. 3 and 4. In some examples (e.g., examples in which the method 900 is performed by a UE 115), the method 900 may include receiving an indicator of a MCS in a transmission grant (e.g., in an uplink grant) and performing the encapsulating, at block 905, in response to the MCS.

Thus, the method 900 may provide for wireless communication. It should be noted that the method 900 is just one implementation and that the operations of the method 900 may be rearranged or otherwise modified such that other implementations are possible.

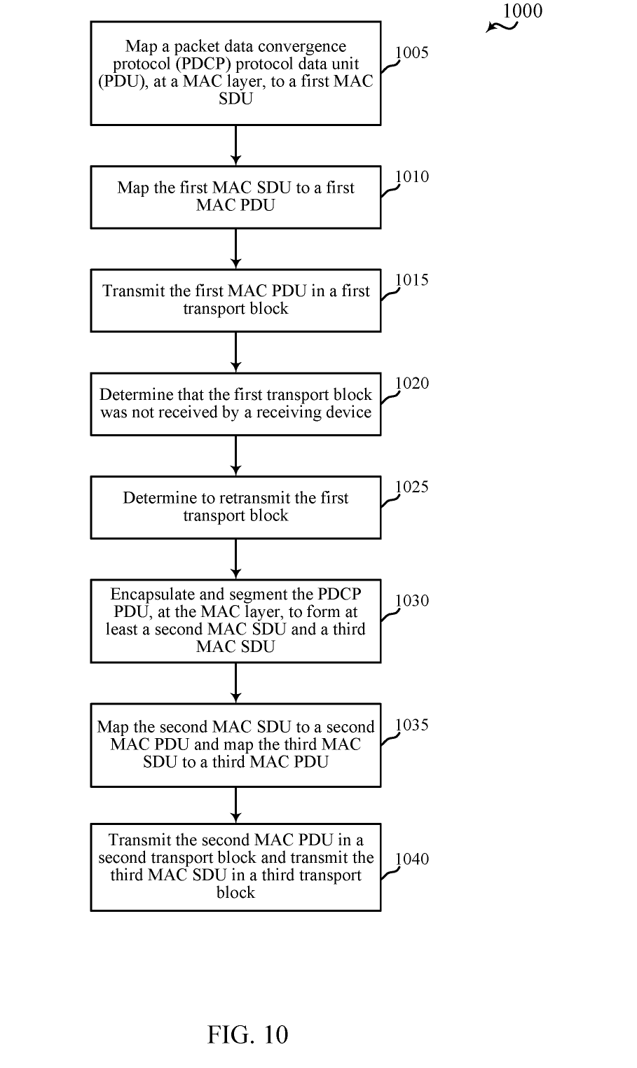

FIG. 10 is a flow chart illustrating an example of a method 1000 for wireless communication, in accordance with various embodiments. For clarity, the method 1000 is described below with reference to aspects of a wireless device, such as a wireless device including aspects of one or more of the base stations 105 or UEs 115 described with reference to FIG. 1, 5, 6, 7, or 8. In some examples, a wireless device may execute one or more sets of codes to control the functional elements of the wireless device to perform the functions described below.

At block 1005, a wireless device may map a PDCP PDU, at a MAC layer, to a first MAC SDU. In some cases, the mapping may be based at least in part on a scheduling decision (e.g., a scheduling decision based at least in part on a transport block size or a MCS). The operation(s) at block 1005 may be performed using the wireless communication management module 520 described with reference to FIG. 5, 6, 7, or 8, or the MAC layer 535 or mapping module 545-a described with reference to FIG. 5 or 6.

At block 1010, the wireless device may map the first MAC SDU to a first MAC PDU. The operation(s) at block 1010 may be performed using the wireless communication management module 520 described with reference to FIG. 5, 6, 7, or 8, or the MAC layer 535 or mapping module 545 described with reference to FIG. 5 or 6.

At block 1015, the wireless device may transmit the first MAC PDU in a first transport block, as part of an initial transmission of the first MAC PDU (and the first MAC SDU and PDCP PDU included therein). In some cases the first MAC SDU may be an only MAC SDU transmitted in the first transport block. In some cases, the first transport block may include a first plurality of MAC SDUs, and thus, a first plurality of PDCP PDUs. The operation(s) at block 1015 may be performed using the wireless communication management module 520 described with reference to FIG. 5, 6, 7, or 8, or the PHY layer 550 or transmission management module 555 described with reference to FIG. 5 or 6.

At block 1020, the wireless device may determine that the first transport block was not received by a receiving device (e.g., by receiving a non-acknowledgement from the receiving device, or by not receiving an acknowledgement from the receiving device).

At block 1025, the wireless device may determine to retransmit the first transport block. In some examples, the information included in the first transport block (e.g., MAC PDU, MAC SDU(s), and MAC PDU(s)) may be retransmitted in a same order, but at a lower MCS. When transmitted at a lower MCS, and assuming a same transport block size, the information may be retransmitted across a plurality of transport blocks. The operation(s) at block 1020 or 1025 may be performed using the wireless communication management module 520 described with reference to FIG. 5, 6, 7, or 8, or the MAC layer 535 described with reference to FIG. 5 or 6, or the ARQ/HARQ module 605 described with reference to FIG. 6.

At block 1030, the wireless device may encapsulate and segment the PDCP PDU, at the MAC layer, to form at least a second MAC SDU and a third MAC SDU. The segmenting may be performed for a retransmission (e.g., an ARQ retransmission or a HARQ retransmission) of the first transport block. In some cases, the segmenting may be based at least in part on a scheduling decision (e.g., a scheduling decision based at least in part on a transport block size or a MCS). In some cases, the MCS on which the segmenting is based may be a lower MCS than the MCS used for transmitting the first transport block. The operation(s) at block 1030 may be performed using the wireless communication management module 520 described with reference to FIG. 5, 6, 7, or 8, or the MAC layer 535 or encapsulating and segmenting module 540 described with reference to FIG. 5 or 6, or the segmenting module 630 described with reference to FIG. 6.

At block 1035, the wireless device may map the second MAC SDU to a second MAC PDU and map the third MAC SDU to a third MAC PDU. The operation(s) at block 1035 may be performed using the wireless communication management module 520 described with reference to FIG. 5, 6, 7, or 8, or the MAC layer 535 or mapping module 545 described with reference to FIG. 5 or 6.

At block 1040, the wireless device may transmit the second MAC PDU in a second transport block and transmit the third MAC PDU in a third transport block. In some cases the second MAC SDU may be an only MAC SDU transmitted in the second transport block, or the third MAC SDU may be an only MAC SDU transmitted in the third transport block. In some cases, the second transport block may include a second plurality of MAC SDUs, and thus, a second plurality of PDCP PDUs. In some cases, the third transport block may include a third plurality of MAC SDUs, and thus, a third plurality of PDCP PDUs. The operation(s) at block 1040 may be performed using the wireless communication management module 520 described with reference to FIG. 5, 6, 7, or 8, or the PHY layer 550 or transmission management module 555 described with reference to FIG. 5 or 6.

In some examples of the method 1000, the PDCP PDU may be one of a plurality of PDCP PDUs, and the method 1000 may include mapping each of the PDCP PDUs to a single MAC SDU or a plurality of MAC SDUs. When a PDCP PDU is mapped to a plurality of MAC SDUs (e.g., as described with reference to block 1005 or 1030), the PDCP PDU may be segmented, at the MAC layer, between the plurality of MAC SDUs.

In some examples of the method 1000, each of the transport blocks transmitted at block 1015 or 1040 may include framing information. The framing information included in a transport block may indicate boundaries of PDCP PDUs or boundaries of segments of PDUs included in the transport block, as described with reference to FIG. 3 or 4.

In some examples of the method 1000, a TBSN or NDI may be transmitted for each of the transport blocks transmitted at block 1015 or 1040. In some cases, the TBSN or NDI for a transport block may be transmitted in at least one of a MAC control element, a MAC sub-header, or DCI on a PDCCH. When the transport blocks are included in a retransmission, a SSN may also be transmitted for each of the transport blocks. The transmission of a TBSN, NDI, and SSN is described in greater detail in FIGS. 3 and 4.

In some examples (e.g., examples in which the method 1000 is performed by a UE 115), the method 1000 may include receiving an indicator of a MCS in a transmission grant (e.g., in an uplink grant) and performing the segmenting, at block 1005 or 1030, in response to the MCS.

Thus, the method 1000 may provide for wireless communication. It should be noted that the method 1000 is just one implementation and that the operations of the method 1000 may be rearranged or otherwise modified such that other implementations are possible.

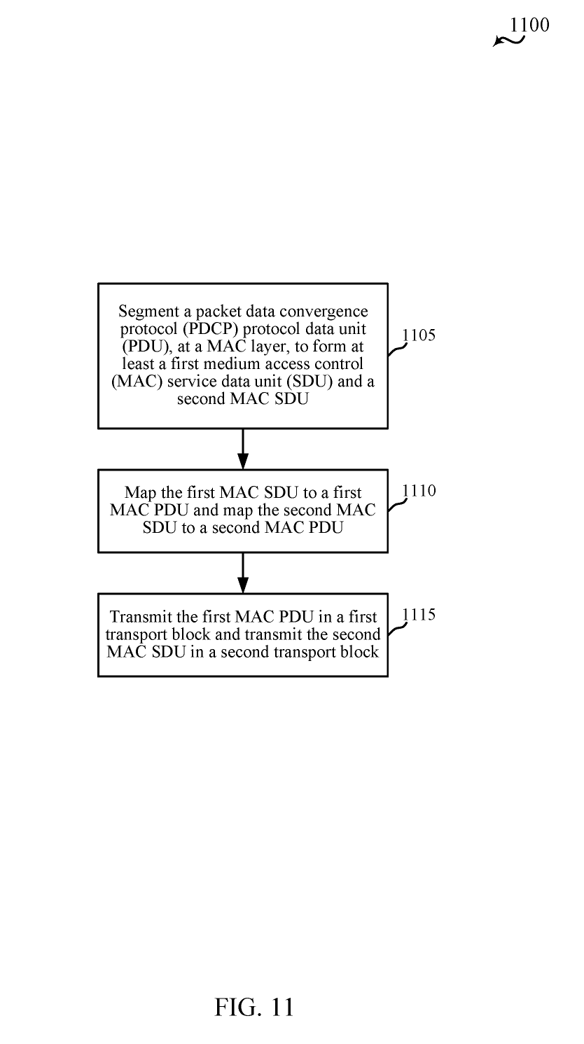

FIG. 11 is a flow chart illustrating an example of a method for wireless communication, in accordance with various embodiments. For clarity, the method 1100 is described below with reference to aspects of a wireless device, such as a wireless device including aspects of one or more of the base stations 105 or UEs 115 described with reference to FIG. 1, 5, 6, 7, or 8. In some examples, a wireless device may execute one or more sets of codes to control the functional elements of the wireless device to perform the functions described below.

At block 1105, a wireless device may segment a packet data convergence protocol (PDCP) protocol data unit (PDU), at a MAC layer, to form at least a first medium access control (MAC) service data unit (SDU) and a second MAC SDU. The operation(s) at block 1105 may be performed using the wireless communication management module 520 described with reference to FIG. 5, 6, 7, or 8, or the MAC layer 535, or the encapsulating module 540 described with reference to FIG. 5 or 6, or the segmenting module 630 described with reference to FIG. 6.

At block 1110, the wireless device may map the first MAC SDU to a first MAC PDU and map the second MAC SDU to a second MAC PDU. The operation(s) at block 1110 may be performed using the wireless communication management module 520 described with reference to FIG. 5, 6, 7, or 8, or the MAC layer 535 or mapping module 545 described with reference to FIG. 5 or 6.

At block 1115, the wireless device may transmit the first MAC PDU in a first transport block and transmit the second MAC PDU in a second transport block. In some cases the first MAC SDU may be an only MAC SDU transmitted in the first transport block, or the second MAC SDU may be an only MAC SDU transmitted in the second transport block. In some cases, the first transport block may include a first plurality of MAC SDUs, and thus, a first plurality of PDCP PDUs. In some cases, the second transport block may include a second plurality of MAC SDUs, and thus, a second plurality of PDCP PDUs. The operation(s) at block 915 may be performed using the wireless communication management module 520 described with reference to FIG. 5, 6, 7, or 8, or the PHY layer 550 or transmission management module 555 described with reference to FIG. 5 or 6.

In some examples of the method 1100, the PDCP PDU may be one of a plurality of PDCP PDUs, and the method 1100 may include mapping each of the PDCP PDUs to a single MAC SDU or a plurality of MAC SDUs. When a PDCP PDU is mapped to a plurality of MAC SDUs (e.g., as described with reference to block 1105), the PDCP PDU may be segmented, at the MAC layer, between the plurality of MAC SDUs.

In some examples of the method 1100, each of the transport blocks transmitted at block 1115 may include framing information. The framing information included in a transport block may indicate boundaries of PDCP PDUs or boundaries of segments of PDUs included in the transport block, as described with reference to FIG. 3 or 4.

In some examples of the method 1100, a TBSN or NDI may be transmitted for each of the transport blocks transmitted at block 1115. In some cases, the TBSN or NDI for a transport block may be transmitted in at least one of a MAC control element, a MAC sub-header, or DCI on a PDCCH. When the transport blocks are included in a retransmission, a SSN may also be transmitted for each of the transport blocks. Additional details on determining and transmitting a TBSN, NDI, or SSN are described in greater detail in FIGS. 3 and 4.

In some examples (e.g., examples in which the method 900 is performed by a UE 115), the method 1100 may include receiving an indicator of a MCS in a transmission grant (e.g., in an uplink grant) and performing the segmenting, at block 1105, in response to the MCS.

Thus, the method 1100 may provide for wireless communication. It should be noted that the method 1100 is just one implementation and that the operations of the method 1100 may be rearranged or otherwise modified such that other implementations are possible.

In some examples, aspects of the methods 900, 1000, and 1100 described with reference to FIGS. 9, 10, and 11 may be combined. It should be noted that the methods 900, 1000, and 1100 are just example implementations, and that the operations of the methods 900, 1000, and 1100 may be rearranged or otherwise modified such that other implementations are possible.

The detailed description set forth above in connection with the appended drawings describes examples and does not represent the only examples that may be implemented or that are within the scope of the claims. The terms “example” and “exemplary,” when used in this description, mean “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a digital signal processor (DSP), an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a non-transitory computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC (i.e., A and B and C).

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, EEPROM, CD-ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a non-transitory computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

The previous description of the disclosure is provided to enable a person skilled in the art to make or use the disclosure. Various modifications to the disclosure will be readily apparent to those skilled in the art, and the generic principles defined herein may be applied to other variations without departing from the spirit or scope of the disclosure. Throughout this disclosure the term “example” or “exemplary” indicates an example or instance and does not imply or require any preference for the noted example. Thus, the disclosure is not to be limited to the examples and designs described herein but is to be accorded the widest scope consistent with the principles and novel features disclosed herein.

What is claimed is:

1. A method for wireless communication, comprising:
encapsulating a packet data convergence protocol (PDCP) protocol data unit (PDU), at a medium access control (MAC) layer, as a first MAC service data unit (SDU);
mapping the first MAC SDU to a first MAC PDU; and
transmitting the first MAC PDU in a first transport block.

2. The method of claim 1, further comprising:
segmenting the PDCP PDU to form the first MAC SDU and a second MAC SDU;
mapping the second MAC SDU to a second MAC PDU; and
transmitting the second MAC PDU in a second transport block.

3. The method of claim 2, further comprising:
transmitting framing information in the first transport block and the second transport block, the framing information indicating boundaries of PDCP PDUs or boundaries of segments of PDCP PDUs included in the first transport block and the second transport block.

4. The method of claim 3, wherein the framing information for a transport block is transmitted in at least one MAC sub-header of the transport block, the framing information indicating whether a MAC SDU corresponds to a beginning segment, a middle segment, or an end segment of a corresponding PDCP PDU.

5. The method of claim 2, further comprising:
transmitting, for the first transport block and the second transport block, one or both of a transport block sequence number (TBSN) and a new data indicator (NDI).

6. The method of claim 5, further comprising:
transmitting, for a transport block included in a retransmission, a segment sequence number (SSN).

7. The method of claim 5, further comprising:
transmitting the TBSN or the NDI in one or more of a MAC control element, a MAC sub-header, and downlink control information (DCI) on a physical data control channel (PDCCH).

8. The method of claim 2, wherein the segmenting is performed for a retransmission of a third transport block comprising the PDCP PDU, the third transport block transmitted prior to the first transport block and the second transport block.

9. The method of claim 8, further comprising:
mapping the PDCP PDU, at the MAC layer, to a third MAC SDU;
mapping the third MAC SDU to a third MAC PDU; and
transmitting the third MAC PDU in the third transport block, prior to the retransmission of the PDCP PDU.

10. The method of claim 8, wherein the retransmission of the third transport block comprising the PDCP PDU comprises one of an automatic repeat request (ARQ) retransmission or a hybrid ARQ (HARD) retransmission.

11. The method of claim 8, further comprising:
retransmitting a plurality of MAC SDUs included in the third transport block, in a same order, across a plurality of transport blocks comprising at least the first transport block and the second transport block.

12. The method of claim 11, wherein the plurality of MAC SDUs retransmitted across the plurality of transport blocks is retransmitted at a different modulation and coding scheme (MCS) than in the third transport block.

13. The method of claim 2, further comprising:
mapping individual PDCP PDUs of a plurality of PDCP PDUs to individual MAC SDUs or to a plurality of MAC SDUs; and
segmenting, at the MAC layer, individual PDCP PDUs mapped to the plurality of MAC SDUs.

14. The method of claim 1, wherein a plurality of PDCP PDUs is transmitted in one or both of the first transport block and the second transport block.

15. The method of claim 1, wherein the first MAC SDU is an only MAC SDU transmitted in the first transport block or the second MAC SDU is an only MAC SDU transmitted in the second transport block.

16. The method of claim 2, wherein the segmenting is based at least in part on one or more of a scheduling decision, a transport block size, and a modulation and coding scheme (MCS).

17. The method of claim 2, further comprising:
receiving an indicator of a modulation and coding scheme (MCS) in a transmission grant; and
performing the segmenting in response to the MCS.

18. An apparatus for wireless communication, comprising:
a processor;
memory in electronic communication with the processor; and
instructions stored in the memory and executable by the processor to cause the apparatus to:
encapsulate a packet data convergence protocol (PDCP) protocol data unit (PDU), at a medium access control (MAC) layer, as a first medium access control (MAC) service data unit (SDU);
map the first MAC SDU to a first MAC PDU; and
transmit the first MAC PDU in a first transport block.

19. The apparatus of claim 18, wherein the instructions executable by the processor to cause the apparatus to encapsulate the PDCP PDU further includes instructions executable by the processor to cause the apparatus to:
segment the PDCP PDU to form the first MAC SDU and a second MAC SDU;
map the second MAC SDU to a second MAC PDU; and
transmit the second MAC PDU in a second transport block.

20. A non-transitory computer-readable medium storing code for wireless communication, the code comprising instructions executable by a processor to:
encapsulate a packet data convergence protocol (PDCP) protocol data unit (PDU), at a medium access control (MAC) layer, as a first medium access control (MAC) service data unit (SDU) and a second MAC SDU;
map the first MAC SDU to a first MAC PDU; and
transmit the first MAC PDU in a first transport block.
